(19) United States
(12) Patent Application Publication
(10) Pub. No.: US 2013/0314677 A1
(43) Pub. Date: Nov. 28, 2013

(54) PROJECTOR WITH DOCKING SYSTEM FOR HANDHELD ELECTRONIC DEVICES

(71) Applicants: Ernesto M. Rodriguez, JR., Austin, TX (US); James K. Kennedy, Round Rock, TX (US)

(72) Inventors: Ernesto M. Rodriguez, JR., Austin, TX (US); James K. Kennedy, Round Rock, TX (US)

(73) Assignee: 3M INNOVATIVE PROPERTIES COMPANY, ST. PAUL (MN)

(21) Appl. No.: 13/984,324

(22) PCT Filed: Feb. 2, 2012
(86) PCT No.: PCT/US12/23564

§ 371 Date: Aug. 8, 2013

Related U.S. Application Data
(60) Provisional application No. 61/442,475, filed on Feb. 14, 2011.

(51) Int. Cl. G03B 21/14

(52) U.S. Cl. CPC G03B 21/145
USPC 353/119

(57) ABSTRACT

A projector includes a cavity configured to accommodate handheld electronic devices having at least one of different sizes and shapes, a communicating unit configured to electrically communicate with a handheld electronic device that is disposed in the cavity, and a projection subsystem configured to project an image that is at least partially formed by a handheld electronic device that is disposed in the cavity.

### TECHNICAL FIELD

The present disclosure relates generally to projectors with a docking system for handheld electronic devices. More particularly, the present invention relates to a docking system that accommodates handheld electronic devices with different shapes and sizes, and with different connectors.

### BACKGROUND

There exist today many styles of handheld electronic devices, such as, e.g., cellular phones, smartphones, personal digital assistants, media players (such as, e.g., music players or video players), cameras, game players and the like. Examples of handheld electronic devices include the iPhone from Apple, Inc., Cupertino, Calif., U.S.A., the BlackBerry from Research In Motion Limited, Waterloo, Ontario, Canada, and smartphones based on the Android operating system. While the compactness of a handheld electronic device is advantageous for portability with regard to, e.g., ordinary voice communication and music playing, this diminution in size, by its very nature, creates a built-in disadvantage with respect to the display of visual data (such as, e.g., a video clip, a movie, or a slide show presentation) because of a small display integrated with the handheld electronic device.

One solution to the above-mentioned problem is to have a projector built into the handheld electronic device. Recent advancement in micro-electromechanical system (MEMS) technology has opened up opportunities for commercialization of micro-projectors built into handheld electronic devices. However, handheld electronic devices with a built-in projector have a relatively high power consumption, in particular when the built-in projector is designed to project relatively large, high quality images. A handheld electronic device is typically powered by a chargeable battery. Although the lifetime of a chargeable battery has been improved significantly over recent years, it remains as one of the key technical challenges for handheld electronic devices with a built-in projector.

Another solution to the above-mentioned small display issue is to connect the handheld device to a projector. Electrical cables exist to establish such a connection. These electrical cables include electrical connectors that are typically dedicated to a particular handheld electronic device and projector. As a result, manufacturers of projectors need to offer a variety of electrical cables compatible with the various handheld electronic devices. An additional issue with such implementation is the lack of portability of the system combining the projector and the handheld electronic device. Although methods exist for interfacing a handheld electronic device to a projector connecting to a wireless network, such implementation has the same lack of portability issue.

Docking systems have been developed to provide a convenient interface for transferring data between a handheld electronic device and a projector without having to reconnect and disconnect electrical cables. As is generally well known, handheld electronic devices come in various shapes and sizes (e.g., thickness, width, and height). The shape and size is typically dependent on various form factors including but not limited to ease of use, ergonomics, aesthetics, and the size of the components inside or outside the device. Docking systems are typically designed to coincide with the shape and size of, and are therefore dedicated to, a particular handheld electronic device. In addition, such implementation has the same lack of portability issue as described above, even when the docking system is integrated into the projector.

Clearly, a need exists for a projector that is configured to cooperate with various handheld electronic devices, providing a portable solution to efficiently and effectively project relatively large, high quality images.

### SUMMARY

In one aspect, the present invention provides a projector including a cavity configured to accommodate handheld electronic devices having at least one of different sizes and shapes, a communicating unit configured to electrically communicate with a handheld electronic device that is disposed in the cavity, and a projection subsystem configured to project an image that is at least partially formed by a handheld electronic device that is disposed in the cavity.

The above summary of the present invention is not intended to describe each disclosed embodiment or every implementation of the present invention. The Figures and detailed description that follow below more particularly exemplify illustrative embodiments.

### BRIEF DESCRIPTION OF THE DRAWINGS

FIG. 1 is a perspective view of an exemplary embodiment of a projector and two handheld electronic devices and corresponding removable inserts according to an aspect of the present invention.

FIG. 2 is a perspective view of an exemplary embodiment of a projector and a handheld electronic device and corresponding removable insert according to an aspect of the present invention in an assembled configuration.

FIG. 3a is a perspective view of a projector and a handheld electronic device and corresponding removable insert according to an aspect of the present invention, wherein the handheld electronic device is positioned for connection to the device-specific electrical connector.

FIG. 3b is a perspective view of a projector and a handheld electronic device and corresponding removable insert according to an aspect of the present invention, wherein the handheld electronic device is connected to the device-specific electrical connector and positioned in a first position.

FIG. 3c is a perspective view of a projector and a handheld electronic device and corresponding removable insert according to an aspect of the present invention, wherein the handheld electronic device is connected to the device-specific electrical connector and positioned in a second position.

FIG. 4 is a block diagram of a projector according to an aspect of the present invention.

FIG. 5 is a schematic view of a projection subsystem of a projector according to an aspect of the present invention.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the invention is defined by the appended claims.

The present application includes various embodiments of a projector configured to cooperate with various handheld electronic devices, through the use of corresponding removable inserts, providing a portable solution to efficiently and effectively project relatively large, high quality images. In one aspect, the projector may simply be a “pass-through” device including minimal electronics. Instead, most of the electronics would be included in the handheld electronic device connected to the projector. This allows for the user, already familiar with the functionality, the on-screen display, and the graphical user interface of the handheld electronic device, to simply operate the projector. In other words, users have the ability to navigate a system (including a system-specific on-screen display and graphical user interface, for example) that is well-known to them (i.e., that of the handheld electronic device) as opposed to having to learn an additional system (i.e., that of the projector). Further, unlike a conventional “fully-burdened” projector that includes items such as, e.g., a graphical user interface, memory, video processing, and an on-screen display, the projector may be simplified to focus on optical performance and, optionally, battery life and acoustic performance as the key attributes of the projector. This beneficially minimizes the cost, complexity, and size of the projector, and eliminates duplication of functions included in the projector and the handheld electronic device.

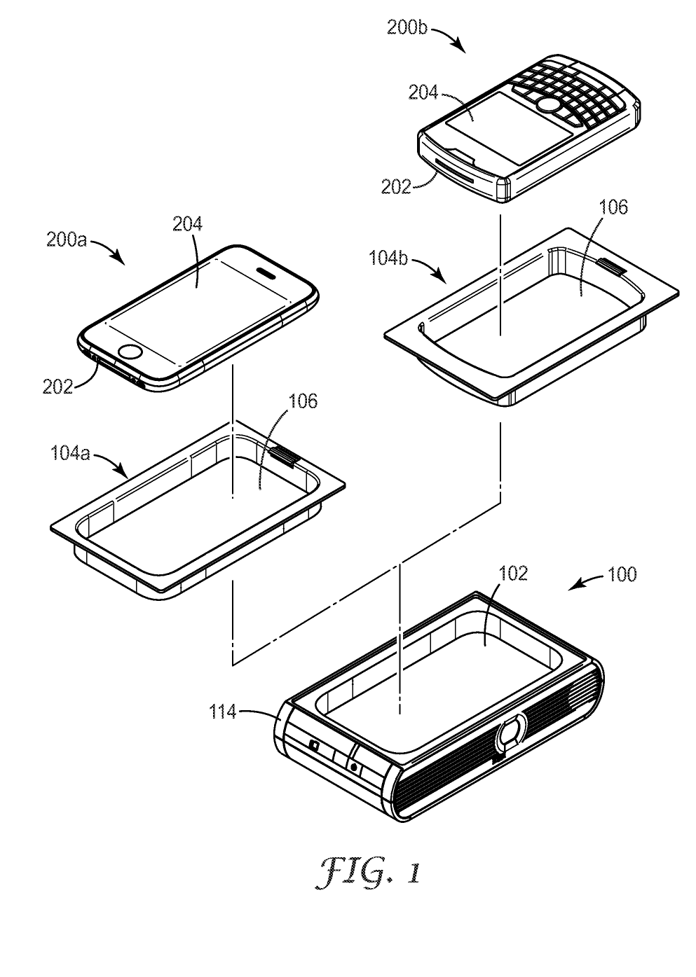

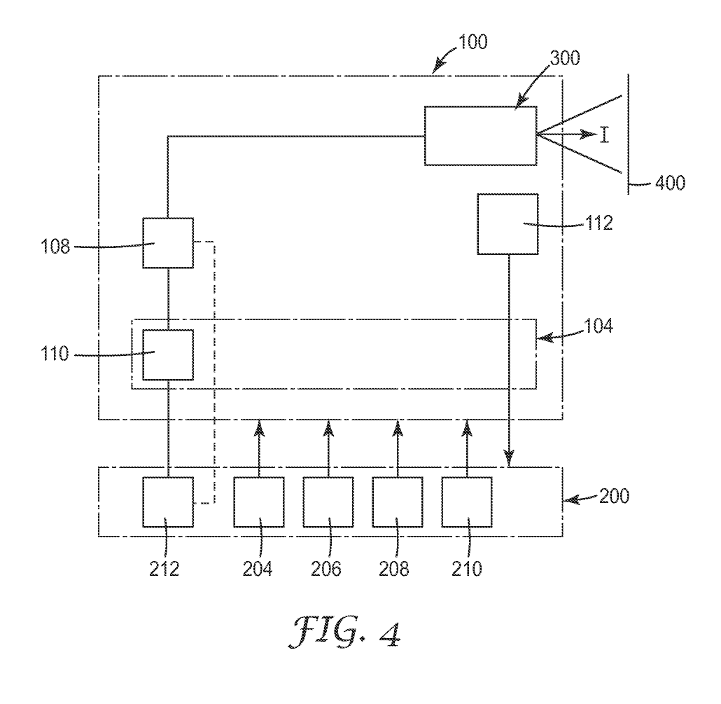

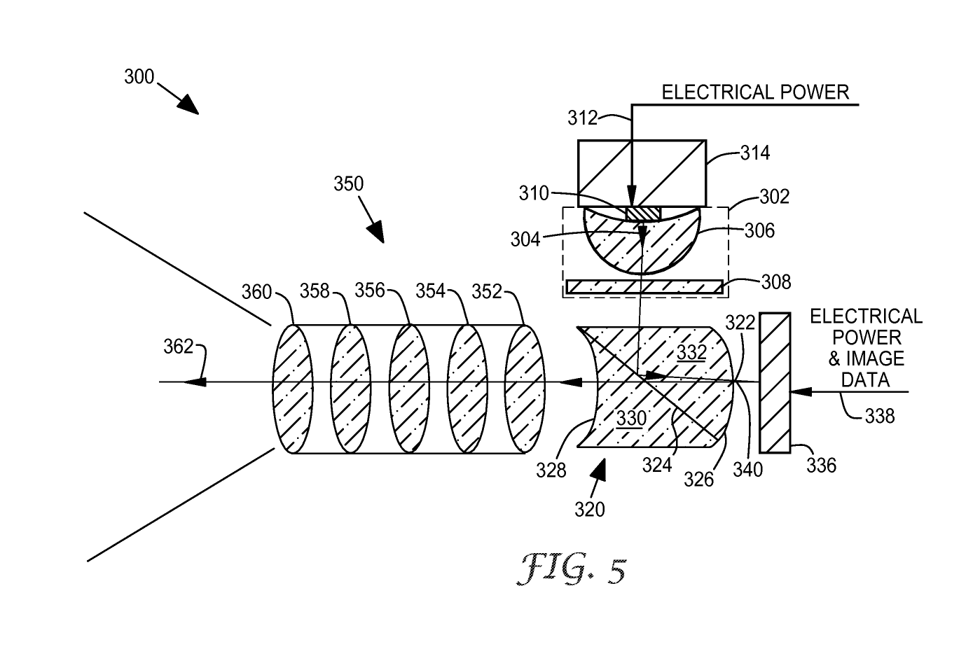

Now referring to the Figures, FIG. 1 illustrates an exemplary embodiment of a projector and two handheld electronic devices and corresponding removable inserts according to an aspect of the present invention. Projector 100 includes a cavity 102 configured to accommodate handheld electronic devices having at least one of different sizes and shapes. As can be seen in FIG. 1, handheld electronic device 200a and handheld electronic device 200b (both also referred to herein as handheld electronic device 200) have a different size and shape. In general, examples of handheld electronic devices 200 that can be used with projector 100 include cellular phones, smartphones, personal digital assistants, media players (such as, e.g., music players or video players), cameras, game players and the like. In the exemplary embodiment illustrated in FIG. 1, handheld electronic device 200a is an iPhone from Apple, Inc., Cupertino, Calif., U.S.A., and handheld electronic device 200b is a BlackBerry from Research In Motion Limited, Waterloo, Ontario, Canada. In other exemplary embodiments, handheld electronic devices 200 may include smartphones based on the Android operating system or any other suitable electronic devices. Although FIG. 1 illustrates two handheld electronic devices 200 having at least one of different sizes and shapes, projector 100 may be configured to accommodate one handheld electronic device 200, or two or more handheld electronic devices 200 having at least one of different sizes and shapes. Projector 100 further includes a communicating unit 108 (shown in FIG. 4) configured to electrically communicate with a handheld electronic device that is disposed in cavity 102. For example, projector 100 is configured to electrically communicate with handheld electronic device 200a when handheld electronic device 200a is disposed in cavity 102, and projector 100 is configured to electrically communicate with handheld electronic device 200b when handheld electronic device 200b is disposed in cavity 102. Projector 100 further includes a projection subsystem 300 (shown in FIG. 5) configured to project an image that is at least partially formed by a handheld electronic device 200 that is disposed in cavity 102. For example, projection subsystem 300 is configured to project an image that is at least partially formed by handheld electronic device 200a when handheld electronic device 200a is disposed in cavity 102, and projection subsystem 300 is configured to project an image that is at least partially formed by handheld electronic device 200b when handheld electronic device 200b is disposed in cavity 102.

In most cases, projector 100 includes a projector housing 114. Projector housing 114 may be configured to retain a projection lens assembly and any other projector components, such as, e.g., a light engine, an image-forming device, and a power source. It may be configured to expose any electrical connections of projector 100, such as, e.g., an external power connection. Projector housing 114 may be configured to expose a portion of the lens assembly to allow an image projection beam to be projected. It may include openings, such as, e.g., holes or slots, to allow any heat generated in projector housing 114 to escape. As can be seen in FIG. 4, in at least one embodiment, projector housing 114 includes communicating unit 108, projection subsystem 300, power source 112, and cavity 102 configured to receive removable inserts 104. In at least one embodiment, cavity 102 is configured such that the handheld electronic device 200 that is disposed in cavity 102 is disposed within projector housing 114, such that projector 100 occupies the same physical space even after placement of a handheld electronic device 200 therein.

In at least one embodiment, projector 100 further includes a removable insert disposed in cavity 102 and configured to accommodate a handheld electronic device 200 having at least one of a particular size and shape. Referring to FIG. 1, projector 100 includes a removable insert 104a configured to accommodate handheld electronic device 200a, and a removable insert 104b configured to accommodate handheld electronic device 200b. As can be seen in FIG. 1, removable insert 104a and removable insert 104b (both generally referred to herein as removable inserts 104) are configured to be disposed in cavity 102. Removable inserts 104 are interchangeable. In at least one embodiment, a plurality of removable inserts 104 may be supplied with projector 100. Removable inserts 104 are configured to be received by projector 100 and to accommodate handheld electronic devices 200 with different sizes and shapes. In essence, removable inserts 104 allow different dimensioned devices to be placed in the same projector. Although FIG. 1 illustrates two handheld electronic devices 200 having at least one of different sizes and shapes and corresponding removable inserts 104, projector 100 may be configured to accommodate one handheld electronic device 200 and corresponding removable insert 104, or two or more handheld electronic devices 200 having at least one of different sizes and shapes and corresponding removable inserts 104.

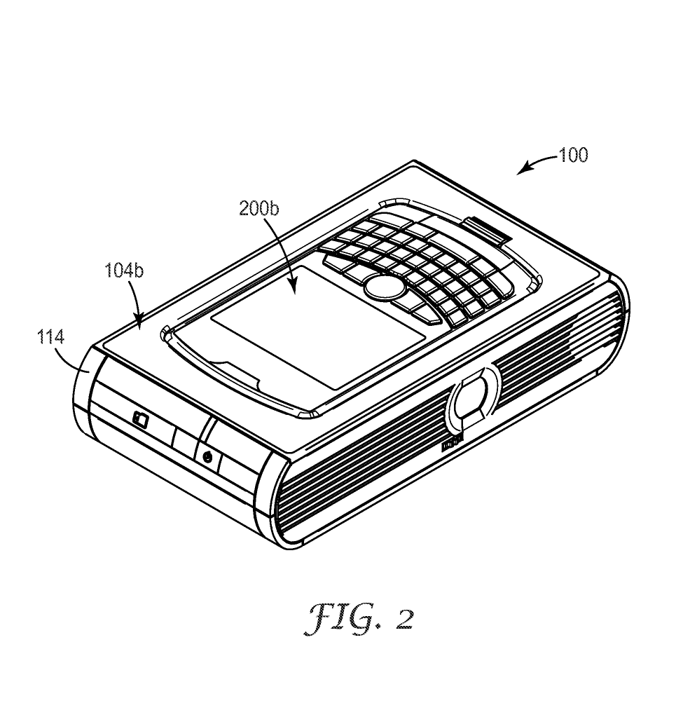

In at least one embodiment, projector 100 includes cavity 102 for receiving each of removable inserts 104, and removable inserts 104 include a receptacle bay 106 that accommodates a back portion 202 of a handheld electronic device 200 with a particular size and shape. That is, cavity 102 in projector 100 is sized and dimensioned to allow each of removable inserts 104 to be positioned therein, and receptacle bay 106 of removable inserts 104 is sized and dimensioned to allow a particular handheld electronic device 200 to be positioned therein. Referring to FIG. 1, removable insert 104a includes a receptacle bay 106 configured to accommodate a back portion 202 of handheld electronic device 200a, and removable insert 104b includes a receptacle bay 106 configured to accommodate a back portion 202 of handheld electronic device 200b. As can be seen in FIG. 1, each receptacle bay 106 substantially correspond to the shape and size of a particular handheld electronic device 200 to be positioned therein. Preferably, cavity 102 in projector 100 and receptacle bays 106 are configured to support handheld electronic devices 200 in a laid down (i.e., horizontal, as shown in FIG. 2) position. In this case, cavity 102 and receptacle bays 106 are typically configured to surround the top and bottom sides and the left and right sides of handheld electronic devices 200. In one aspect, this configuration allows handheld electronic devices 200 to be disposed within projector 100, such that projector 100 occupies the same physical space even after placement of a handheld electronic device 200 therein. An example of this configuration can be seen in FIG. 2, wherein handheld electronic device 200b is positioned in receptacle bay 106 of removable insert 104b, which is positioned in cavity 102 of projector 100. Alternatively, cavity 102 in projector 100 and receptacle bays 106 may be configured to support handheld electronic devices 200 in an upright (i.e., vertical or angled) position. In this case, cavity 102 and receptacle bays 106 are typically configured to surround the front, back, and left and right sides of handheld electronic devices 200. In either case, access to a graphical user interface 204 of handheld electronic devices 200 is preferably maintained.

In at least one embodiment, projector 100 includes a handheld projector. As can be seen in FIG. 2, projector 100 is not much larger than the handheld electronic device 200 disposed therein, which allows a user to operate projector 100, using the handheld electronic device 200, while holding projector 100 in his/her hand. It also allows a user to carry and store projector 100 substantially the same as he/she would the handheld electronic device 200. In certain embodiments, projector 100 may be configured and function as a protective sleeve for the handheld electronic device 200 disposed therein. In certain embodiments, projector 100 has a length that is less than twice the length of the handheld electronic device 200, a width that is less than twice the width of the handheld electronic device 200, and a thickness that is less than five times the thickness of the handheld electronic device 200. For example, handheld electronic device 200a, an iPhone from Apple, Inc., Cupertino, Calif., U.S.A., has a length of about 115.2 mm, a width of about 58.6 mm, and a thickness of about 9.3 mm, while projector 100 has a length of about 146 mm (about 1.27 times the length of the iPhone), a width of about 80 mm (about 1.37 times the width of the iPhone) and a thickness of about 33 mm (about 3.55 times the thickness of the iPhone). The ongoing miniaturization of handheld electronic devices 200 projector 100 is configured to accommodate allows projector 100 to be made smaller as well. In addition, the ongoing miniaturization of projection lens assemblies and other projector components, such as, e.g., light engines, image-forming devices, and power sources, allows projector 100 to be made closer in size and/or shape to handheld electronic devices 200 projector 100 is configured to accommodate. For example, projector 100 may have at least one of a length, width, and thickness that approaches the length, width, and thickness, respectively, of the handheld electronic devices 200.

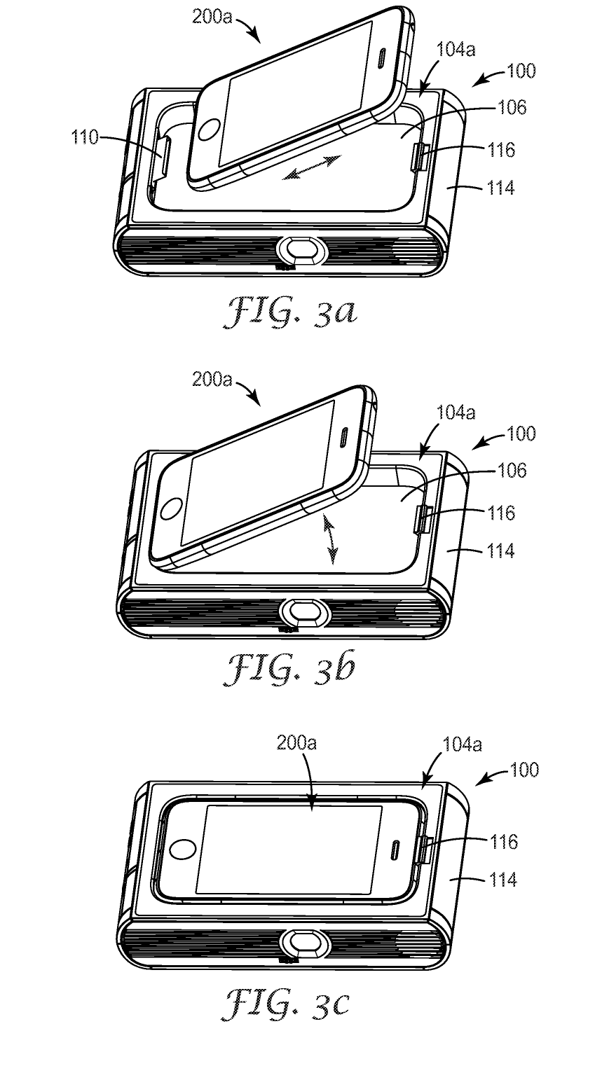

Referring to FIGS. 3a-3c and 4, in at least one embodiment, removable inserts 104 include a device-specific electrical connector 110 configured to connect to a handheld electronic device 200 to transmit electrical signals. Device-specific electrical connector 110 may include an HDMI type connector, a DVI connector, a VGA connector, a D-sub connector, an S terminal connector, an RCA connector, a 3RCA connector, an optical fiber connector, a male 30-pin connector, a Micro USB connector, or any other suitable connector. Typically, device-specific electrical connector 110 is selected to connect with a communicating unit 212 of a handheld electronic device 200 to transmit electrical signals. This configuration enables electrical signals to be transmitted from a handheld electronic device 200 to projector 100 and vise versa.

In at least one embodiment, device-specific electrical connector 110 resiliently rotates between a first position (FIGS. 3a-3b), where handheld electronic device 200 is capable of being connected to or disconnected from device-specific electrical connector 110, and a second position (FIG. 3c), where handheld electronic device 200 is connected to device-specific electrical connector 110 and disposed in cavity 102. This resilient rotation of device-specific electrical connector 110 may be facilitated by a spring or any other suitable method/structure that urges device-specific electrical connector 110 toward a stop (not shown) corresponding to the first position. In at least one embodiment, the first position is a position wherein the device-specific electrical connector plane, defined by the mating direction of device-specific electrical connector 110, and the projector plane, defined by the length and width direction of projector 100, are at an angle with respect to each other. This angle may be any angle suitable to allow handheld electronic device 200 to be connected to or disconnected from device-specific electrical connector 110. In certain embodiments, this angle is in the range of about 0° to about 90° or, more specifically, in the range of about 15° to about 75°. In one embodiment, this angle is about 45°. In at least one embodiment, the second position is a position wherein the device-specific electrical connector plane and the projector plane are substantially parallel.

To position handheld electronic device 200 in projector 100, first, a user generally aligns handheld electronic device 200 with projector 100, e.g., by using device-specific electrical connector 110 and/or receptacle bay 106 as a reference, as shown in FIG. 3a. Then, the user connects handheld electronic device 200 to device-specific electrical connector 110, as shown in FIG. 3b. At this stage, device-specific electrical connector 110 is still in the first position. Then, the user pushes handheld electronic device 200, connected to device-specific electrical connector 110, toward projector 100, whereby handheld electronic device 200 and device-specific electrical connector 110 resiliently rotate from the first position toward the second position. In one aspect, the resilience associated with device-specific electrical connector 110 is sufficiently low such that the user can comfortably push handheld electronic device 200 toward projector 100 without it causing damage to handheld electronic device 200 or device-specific electrical connector 110, and yet sufficiently high such that handheld electronic device 200 and device-specific electrical connector 110 return to the first position when the user releases handheld electronic device 200. When handheld electronic device 200 and device-specific electrical connector 110 arrive in the second position, they are retained in this position using any suitable method/structure, including but not limited to snap fit, friction fit, press fit, and mechanical clamping. In the embodiment illustrated in FIGS. 3a-3c, removable insert 104 includes a resilient latch 116 configured to retain handheld electronic device 200 and device-specific electrical connector 110 in the second position, as shown in FIG. 3c.

To remove handheld electronic device 200 from projector 100, first, handheld electronic device 200 and device-specific electrical connector 110 are released from the second position. In the embodiment illustrated in FIGS. 3a-3c, the user operates resilient latch 116, whereby handheld electronic device 200 and device-specific electrical connector 110 return to the first position by the resilience associated with device-specific electrical connector 110. Then, the user disconnects handheld electronic device 200 from device-specific electrical connector 110 to remove handheld electronic device 200 from projector 100.

In at least one embodiment, communicating unit 108 of projector 100 includes a universal electrical connector. The universal electrical connector may be selected from any suitable existing connector type or may be designed as suitable for the intended application. The universal electrical connector is configured to connect to device-specific electrical connector 110 to transmit electrical signals. Beneficially, the universal electrical connector is configured such that different device-specific electrical connectors 110 can be connected to it. This allows different removable inserts 104 to be disposed in projector 100 such that different handheld electronic devices 200 can be positioned in and connected to projector 100.

In at least one embodiment, communicating unit 108 of projector 100 includes a wireless communication module. The wireless communication module may include a Bluetooth communication module, an NFC module, a UWB communication module, a WiMAX communication module, a cellular communication module, or any other suitable communication module. The wireless communication module is configured to wirelessly connect to a handheld electronic device 200 disposed in cavity 102 to transmit electrical signals. Represented by the dotted line in FIG. 4, the wireless communication may take place between communicating unit 108 of projector 100 and communicating unit 212 of the handheld electronic device 200, wherein communicating unit 108 of projector 100 and communicating unit 212 of the handheld electronic device 200 include corresponding wireless communication modules. In this case, device-specific electrical connector 110 of removable inserts 104 may be omitted.

Referring to FIG. 4, in at least one embodiment, projection subsystem 300 is coupled to communicating unit 108 of projector 100 to convert electrical signals from a handheld electronic device 200 disposed in cavity 102 of projector 100 into an image on a surface 400. Projection subsystem 300 is configured to project an image that is at least partially formed by a handheld electronic device 200 that is disposed in cavity 102 of projector 100. In one aspect, this means that the handheld electronic device 200 may provide electrical image data representing the image and that projection subsystem 300 may contribute to the formation of the image. For example, projection subsystem 300 may include a light engine, an image-forming device, and a projection lens assembly. The light engine provides a light beam. The image-forming device receives image data from the handheld electronic device 200 and receives at least a component of the light beam. The image-forming device provides the image. The projection lens assembly receives the image and provides an image projection beam I having a projected luminous flux level suitable for viewing.

In at least one embodiment, projection subsystem 300 is configured to project an image that is fully formed by a handheld electronic device 200 that is disposed in cavity 102 of projector 100. In one aspect, this means that the handheld electronic device 200 may provide the image and that projection subsystem 300 does not contribute to the formation of the image. For example, projection subsystem 300 may include a projection lens assembly that receives the image and that provides an image projection beam I based on the image and having a projected luminous flux level suitable for viewing. In this case, projection subsystem 300 may not include a light engine and may not include an image-forming device.

Still referring to FIG. 4, unlike a conventional “fully-burdened” projector, projector 100 has been simplified to focus on optical performance (e.g., through projection subsystem 300) and battery life (e.g., through power source 112) as the key attributes of the projector. In at least one embodiment, power source 112 provides power to one or more components of projector 100. In at least one embodiment, power source 112 provides power to handheld electronic device 200 disposed in cavity 102 of projector 100 to power or charge the handheld electronic device 200. In one aspect, projector 100 may simply function as a charger or power source for handheld electronic device 200, aside from its projection capabilities. In other words, handheld electronic device 200 may be charged or powered regardless of whether projector 100 is in use or not. Power source 112 may be any suitable type of power source, such as, e.g., a rechargeable battery unit that can be recharged through an external power source.

Unlike a conventional “fully-burdened” projector, items including a graphical user interface, memory, video processing, and an on-screen display are not included in projector 100. Instead, one or more of these items may be provided for projector 100 by handheld electronic device 200. This beneficially minimizes the cost, complexity, and size of the projector, and eliminates duplication of functions included in the projector and the handheld electronic device. Handheld electronic device 200 illustrated in FIG. 4 provides a graphical user interface 204, memory 206, video processing through a video processor 208, and an on-screen display 210.

Graphical user interface 204 allows users to interact with handheld electronic device 200 and projector 100 through images rather than text commands. Graphical user interface 204 represents the information and actions available to a user through graphical icons and visual indicators such as secondary notation (e.g., position, indentation, color, or symmetry), as opposed to text-based interfaces, typed command labels, or text navigation. The actions are usually performed through direct manipulation of the graphical elements.

Memory 206 is configured to store data in support of handheld electronic device 200 and projector 100. With respect to handheld electronic device 200, memory 206 typically provides a high capacity storage capability for handheld electronic device 200 and stores data that can be used to run handheld electronic device 200. With respect to projector 100, memory 206 is configured to store image data that can be received by projector 100 to project an image and data that can be used to run projector 100. Memory 206 may include memory internal to handheld electronic device 200, such as, e.g., RAM, ROM, or flash memory, and memory external to handheld electronic device 200, such as, e.g., flash drives (e.g., USB flash drives) and memory cards (e.g., SD cards, MicroSD cards, CF cards) that can be inserted in handheld electronic device 200.

Video processor 208 is configured to perform video processing. Video processing is a particular case of signal processing that converts incoming video signals to the native resolution, i.e., the physical resolution determined by a fixed matrix of imaging pixels, of a particular fixed-pixel display. In addition to scaling the image to fit the native resolution, video processing normally enhances the image and remove artifacts caused by the conversion and transmission of video. Video processing can make a significant difference in overall picture quality and has the objective to retain as much of the nuance, detail, and intent of the original source as possible.

On-screen display 210 is a secondary image superimposed on the primary image, used to display information associated with handheld electronic device 200, projector 100 and/or the primary image or image data provided by handheld electronic device 200 to projector 100. For example, on-screen display 210 may display a menu with functions and adjustments for handheld electronic device 200, a menu with functions and adjustments for projector 100, and meta data associated with the projected image. Examples of functions and adjustments include brightness, contrast, position, zoom, keystone, picture, color, time, language, menu location, and device/projector management, to name a few. On-screen display 210 may be configured to display special on-screen messages, such as, e.g., “Going to Standby”, indicating that projector 100 is entering a sleep mode or is powering off On-screen display 210 may include an “enhanced keyboard”, which often includes additional media keys for actions like skipping through music or video tracks and volume adjustment. On-screen display 210 may be displayed with or without an input source present.

Exemplary embodiments of a projector according to aspects of the present invention may include any projection subsystem suitable for the intended application. Examples of projection subsystems that can be used are shown and described in U.S. Patent Application Publication No. 2008/0049190, incorporated by reference herein in its entirety.

For mobile applications it is desirable to project images of diagonal size 12 cm or more, under ambient lighting conditions, which would generally require at least 3 lumens flux and at least 30:1 contrast ratio for good viewability. Additional desired features to provide good image quality can include a large number of resolvable pixels, wide color gamut, and image uniformity.

For mobile applications “portability efficacy” will be defined as a combined measure of the small size, high power efficiency and luminous output of the projection subsystem. The portability efficacy increases as the efficiency of a projection subsystem increases, and increases as the volume of a projection subsystem decreases. Projection subsystems have increased portability when power efficiency is higher and the volume is smaller.

Desired features for projection subsystems include a high level of optical flux in the projected image, large screen size, high contrast, large pixel content, and a wide color gamut. Projection subsystems with incoherent light sources are able to provide useful combinations of the desired features.

Ambient lighting levels in projection environments do not scale down when a projector design is miniaturized or scaled down. A sufficient projection light power level is desired in order to provide a projection image that is bright enough for a group of viewers in the presence of ambient light. If the size of a light emitting source were to be miniaturized, for example, and the same electrical power level were to be applied to the smaller light emitting source, increased temperature rises would be encountered in the smaller light emitting source that could cause overheating. There is a need to optimize the optical efficiency of the projector optics in order to scale down electrical power level to avoid overheating the small light emitting source without reducing the luminous flux of the projected image output. While high power solid state lasers that can efficiently produce highly collimated, coherent light might improve power efficiency, the use of coherent light may produce speckle, decreasing projected image quality. Also, the use of laser light raises concerns about eye safety, particularly under electrical or mechanical fault conditions.

As illustrated in the embodiment described below, optical components are assembled in improved combinations to reach desired high levels of luminous flux with low levels of electrical power in a miniature projection subsystem. The use of coherent light sources is avoided. The portability efficacy of the projection subsystem is enhanced. In particular, many optical losses that typically occur when light passes through air between conventional projector optics components are avoided.

Projection subsystems disclosed herein are capable of operation in a region which has high portability efficacy. The region is limited to a volume of no more than 14 cubic centimeters and an efficiency of no less than 3.8 lumens for 1 watt.

Another measure of portability efficacy comprises a thickness of a projection subsystem along its thinnest axis. A projection subsystem is best suited for use in a pocket portable device when the projection subsystem has a thickness of less than 14 millimeters along a thickness axis. Another aspect of portability efficacy is luminous flux. An projection subsystem is best suited for use in a pocket portable device when the luminous flux is at least 3 lumens.

FIG. 5 illustrates an exemplary projection subsystem 300 that can be used in projector 100. Projection subsystem is configured to project an image that is at least partially formed by a handheld electronic device 200 that is disposed in cavity 102. Projection subsystem 300 is useful for projecting still or video images from miniature electronic systems such as cell phones, personal digital assistants (PDA's), global positioning system (GPS) receivers. Projection subsystem 300 receives electrical power and image data from the miniature electronic system (not illustrated in FIG. 5) into which it is embedded. Projection subsystem 300 is useful as a component part of a miniature projector accessory for displaying computer video. Projection subsystem 300 is useful in systems that are small enough to be carried, when not in use, in a pocket of clothing, such as a shirt pocket. Images projected by the projection subsystem 300 can be projected onto a reflective projection screen, a light-colored painted wall, a whiteboard or sheet of paper or other known projection surfaces. Projection subsystem 300 can be embedded, for example, in a portable computer such as a laptop computer or a cell phone.

Projection subsystem 300 comprises a light engine 302. The light engine 302 provides a light beam 304. The light engine includes a collection lens 306, a collimator 308 and a solid state light emitter 310. According to one aspect, the collection lens 306 comprises a hyperhemispheric ball lens. According to one aspect, the hyperhemispheric ball lens is arranged as taught in U.S. Patent Publication US 2007/0152231, the contents of which are hereby incorporated by reference.

The solid state light emitter 310 receives electrical power 312 with an electrical power level. The solid state light emitter 310 thermally couples to a heat sink 314. The solid state light emitter provides an emitter light beam with an emitter luminous flux level. According to one aspect, the light beam 304 comprises incoherent light. According to another aspect the light beam 304 comprises illumination that is a partially focused image of the solid state light emitter 310. According to yet another aspect the solid state light emitter 310 comprises one or more light emitting diodes (LED's). According to another aspect, the collection lens 306 comprises a hemispheric ball lens. According to another aspect, the collimator 308 comprises a focusing unit comprising a first fresnel lens having a first non-faceted side for receiving a first non-collimated beam and a first faceted side for emitting the collimated beam; and a second fresnel lens having a second non faceted side for substantially directly receiving the collimated beam and second faceted side for emitting an output beam. According to another aspect the solid state light emitter 310 can be arranged as shown in U.S. Provisional Application 60/820,883. According to another aspect the light engine 302 can be arranged as shown in U.S. Provisional Applications 60/820,887, 60/820,888, 60/821,032, 60/838,988.

The projection subsystem 300 comprises a refractive body 320. The refractive body 320 receives the light beam 304. The refractive body 320 provides a polarized beam 322. The refractive body 320 includes an internal polarizing filter 324. One polarized component of the light beam 304 is reflected by the internal polarizing filter 324 to form the polarized beam 322. According to one aspect, the refractive body is formed or utilized according to one or more aspects of U.S. Patent Publication US 2007/0023941 A1 Duncan et al., U.S. Patent Publication US 2007/0024981 A1 Duncan et al., U.S. Patent Publication US 2007/0085973 A1 Duncan et al., and U.S. Patent Publication US 2007/0030456 Duncan et al., all of which are hereby incorporated by reference in their entirety. The refractive body 320 comprises a first external lens surface 326 and a second external lens surface 328. According to one aspect, the external lens surfaces 326, 328 have curved lens surfaces and have non-zero lens power. According to another aspect, the external lens surface 326 comprises a convex lens surface that is useful in maintaining a small volume for the projection subsystem 300. According to another aspect, the external lens surfaces 326, 328 are flat. According to one aspect, the refractive body 320 comprises plastic resin material bodies 330, 332 on opposite sides of the internal polarizing filter 324. According to another aspect, the internal polarizing filter 324 comprises a multilayer optical film. According to another aspect, the refractive body 320 comprises a multifunction optical component that functions as a polarizing beam splitter as well as a lens. By combining the polarizing beam splitter and lens functions in a multifunction refractive body, losses that would otherwise occur at air interfaces between separate beam splitters and lenses are avoided.

The projection subsystem 300 comprises an image-forming device 336. The image-forming device 336 receives image data on electrical input bus 338. The image-forming device 336 receives the polarized beam 322. The image-forming device 336 selectively reflects the polarized beam 322 according to the image data. The image-forming device 336 provides an image 340 with a polarization that is rotated relative to the polarization of the polarized beam 322. The image-forming device 336 provides the image 340 to the refractive body 320. The image 340 passes through the internal polarizing filter 324. According to one aspect, the image-forming device 336 comprises a liquid crystal on silicon (LCOS) device.

The projection subsystem 300 comprises a projection lens assembly 350. The projection lens assembly 350 comprises multiple lenses indicated schematically at 352, 354, 356, 358, 360. The projection lens assembly 350 receives the image 340 from the refractive body 320. The projection lens assembly 350 provides an image projection beam 362 having a projected luminous flux that is suitable for viewing. According to one aspect the projected luminous flux is no less than 3 lumens. According to another aspect, a ratio of the projected luminous flux to the electrical power level is at least 3.8 lumens for 1 watt. According to another aspect, the ratio of the projected luminous flux to electrical power level is at least 7 lumens per watt. According to another aspect, the ratio of projected luminous flux to electrical power level is at least 10 lumens per watt. According to another aspect, the collection efficiency ratio is at least 38.5%. The collection efficiency ratio is defined as a ratio of the polarized luminous flux impinging on an active surface of the image-forming device 336 to the luminous flux emitted from the unpolarized solid state light emitter 310.

According to another aspect, the projection subsystem 300 has an electrical power level of no more than 3.6 watts. According to another aspect, the projection subsystem 300 has a volume of less than 14 cubic centimeters. According to another aspect, the projection subsystem 300 has a thickness of less than 14 millimeters.

According to another aspect, the projection subsystem 300 has an F number that is less than 2.4. According to another aspect, the projection subsystem has an ANSI contrast ratio of at least 30:1. According to another aspect, the projection subsystem has an ANSI contrast ratio of at least 50:1. According to another aspect, the projection subsystem has an on/off contrast ratio of at least 100:1.

In each of the embodiments and implementations described herein, the various exemplary embodiments of a projector according to an aspect of the present invention and elements thereof are formed of any suitable material. The materials are selected depending upon the intended application and may include both metals and non-metals (e.g., any one or combination of non-conductive materials including but not limited to polymers, glass, and ceramics). In at least one embodiment, removable inserts 104, projector housing 114, resilient latch 116, and connector bodies of device-specific electrical connector 110 and the universal electrical connector are formed of a polymeric material by methods such as injection molding, extrusion, casting, machining, and the like, while electrical contacts of device-specific electrical connector 110 and the universal electrical connector are formed of metal by methods such as molding, casting, stamping, machining, and the like. Material selection will depend upon factors including, but not limited to, chemical exposure conditions, environmental exposure conditions including temperature and humidity conditions, flame-retardancy requirements, material strength, and rigidity, to name a few.

Following are exemplary embodiments of a projector according to aspects of the present invention.

Embodiment 1 is a projector comprising: a cavity configured to accommodate handheld electronic devices having at least one of different sizes and shapes; a communicating unit configured to electrically communicate with a handheld electronic device that is disposed in the cavity; and a projection subsystem configured to project an image that is at least partially formed by a handheld electronic device that is disposed in the cavity.

Embodiment 2 is the projector of embodiment 1 further comprising a removable insert disposed in the cavity and configured to accommodate a handheld electronic device having at least one of a particular size and shape.

Embodiment 3 is the projector of embodiment 2, wherein the removable insert includes a receptacle bay that accommodates a back portion of the handheld electronic device.

Embodiment 4 is the projector of embodiment 2, wherein the removable insert includes a device-specific electrical connector configured to connect to the handheld electronic device to transmit electrical signals.

Embodiment 5 is the projector of embodiment 4, wherein the device-specific electrical connector includes an HDMI type connector, a DVI connector, a VGA connector, a D-sub connector, an S terminal connector, an RCA connector, a 3RCA connector, an optical fiber connector, a male 30-pin connector, or a Micro USB connector.

Embodiment 6 is the projector of embodiment 4, wherein the device-specific electrical connector resiliently rotates between a first position, where the handheld electronic device is capable of being connected to or disconnected from the device-specific electrical connector, and a second position, where the handheld electronic device is connected to the device-specific electrical connector and disposed in the cavity.

Embodiment 7 is the projector of embodiment 4, wherein the communicating unit includes a universal electrical connector configured to connect to the device-specific electrical connector to transmit electrical signals.

Embodiment 8 is the projector of embodiment 1, wherein the communicating unit includes a wireless communication module configured to wirelessly connect to the handheld electronic device disposed in the cavity to transmit electrical signals.

Embodiment 9 is the projector of embodiment 8, wherein the wireless communication module includes a Bluetooth communication module, an NFC module, a UWB communication module, a WiMAX communication module, or a cellular communication module.

Embodiment 10 is the projector of embodiment 1 further comprising a power source for providing power to the handheld electronic device.

Embodiment 11 is the projector of embodiment 1, wherein the handheld electronic device provides a graphical user interface for the projector.

Embodiment 12 is the projector of embodiment 1, wherein the handheld electronic device provides memory for the projector.

Embodiment 13 is the projector of embodiment 1, wherein the handheld electronic device provides video processing for the projector.

Embodiment 14 is the projector of embodiment 1, wherein the handheld electronic device provides an on-screen display for the projector.

Embodiment 15 is the projector of embodiment 1 further comprising a projector housing, wherein the handheld electronic device is disposed within the projector housing.

Embodiment 16 is the projector of embodiment 1, wherein the projector includes a handheld projector.

Embodiment 17 is the projector of embodiment 1, wherein the projection subsystem is coupled to the communicating unit to convert electrical signals from the handheld electronic device into an image on a surface.

Embodiment 18 is the projector of embodiment 1, wherein the projection subsystem includes: a light engine that provides a light beam, the light engine including a collection lens, a collimator, and at least one solid state incoherent light emitter that receives an electrical power level and that is coupleable to a heat sink and that provides a light beam with an emitter luminous flux level; an image-forming device that receives image data and that receives at least a component of the light beam, the image-forming device providing an image; and a projection lens assembly that receives the image and that provides an image projection beam having a projected luminous flux level.

Embodiment 19 is the projector of embodiment 18, wherein the projection subsystem further includes a portability efficacy that comprises a ratio of luminous flux to electrical power level of at least 3.8 lumens for 1 watt, and a projection subsystem volume of less than 14 cubic centimeters.

Embodiment 20 is the projector of embodiment 1, wherein the projection subsystem does not include a light engine and does not include an image-forming device.

Embodiment 21 is the projector of embodiment 1, wherein the projection subsystem is configured to project an image that is fully formed by a handheld electronic device that is disposed in the cavity.

Embodiment 22 is the projector of embodiment 1, wherein the projector has a length that is less than twice the length of the handheld electronic device, a width that is less than twice the width of the handheld electronic device, and a thickness that is less than five times the thickness of the handheld electronic device.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electronics, and optical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A projector comprising:
a cavity configured to accommodate handheld electronic devices having at least one of different sizes and shapes;
a communicating unit configured to electrically communicate with a handheld electronic device that is disposed in the cavity; and
a projection subsystem configured to project an image that is at least partially formed by a handheld electronic device that is disposed in the cavity.

2. The projector of claim 1 further comprising a removable insert disposed in the cavity and configured to accommodate a handheld electronic device having at least one of a particular size and shape.

3. The projector of claim 2, wherein the removable insert includes a receptacle bay that accommodates a back portion of the handheld electronic device.

4. The projector of claim 2, wherein the removable insert includes a device-specific electrical connector configured to connect to the handheld electronic device to transmit electrical signals.

5. The projector of claim 4, wherein the device-specific electrical connector resiliently rotates between a first position, where the handheld electronic device is capable of being connected to or disconnected from the device-specific electrical connector, and a second position, where the handheld electronic device is connected to the device-specific electrical connector and disposed in the cavity.

6. The projector of claim 4, wherein the communicating unit includes a universal electrical connector configured to connect to the device-specific electrical connector to transmit electrical signals.

7. The projector of claim 1, wherein the communicating unit includes a wireless communication module configured to wirelessly connect to the handheld electronic device disposed in the cavity to transmit electrical signals.

8. The projector of claim 1 further comprising a power source for providing power to the handheld electronic device.

9. The projector of claim 1, wherein the handheld electronic device provides at least one of a graphical user interface memory, video processing, and an on-screen display for the projector, wherein the handheld electronic device provides memory for the projector, wherein the handheld electronic device provides video processing for the projector, wherein the handheld electronic device provides an on-screen display for the projector.

10. The projector of claim 1 further comprising a projector housing, wherein the handheld electronic device is disposed within the projector housing.

11. The projector of claim 1, wherein the projection subsystem is coupled to the communicating unit to convert electrical signals from the handheld electronic device into an image on a surface.

12. The projector of claim 1, wherein the projection subsystem includes:
a light engine that provides a light beam, the light engine including a collection lens, a collimator, and at least one solid state incoherent light emitter that receives an electrical power level and that is coupleable to a heat sink and that provides a light beam with an emitter luminous flux level;
an image-forming device that receives image data and that receives at least a component of the light beam, the image-forming device providing an image; and
a projection lens assembly that receives the image and that provides an image projection beam having a projected luminous flux level.

13. The projector of claim 1, wherein the projection subsystem does not include a light engine and does not include an image-forming device.

14. The projector of claim 1, wherein the projection subsystem is configured to project an image that is fully formed by a handheld electronic device that is disposed in the cavity.

15. The projector of claim 1, wherein the projector has a length that is less than twice the length of the handheld electronic device, a width that is less than twice the width of the handheld electronic device, and a thickness that is less than five times the thickness of the handheld electronic device.
